(19) United States
(12) Patent Application Publication
(10) Pub. No.: US 2019/0326657 A1
(43) Pub. Date: Oct. 24, 2019

(54) METHOD OF MAKING A ROD ANTENNA

(71) Applicant: Hirschmann Car Communication GmbH, Neckartenzlingen (DE)

(72) Inventors: Ingo HEILEMANN, Tuebingen (DE); Peter RINDHOFER, Neckartenzlingen (DE); Rainer SCHIEMANN, Esslingen-Berkhelm (DE)

(21) Appl. No.: 16/311,716

(22) PCT Filed: Jun. 29, 2017
(86) PCT No.: PCT/EP2017/066014

§ 371 Date: Dec. 20, 2018

(30) Foreign Application Priority Data
Jun. 29, 2016 (DE) 10 2016 111 919.9

(51) Int. Cl. H01Q 1/20; B23P 11/02; H01Q 1/12; H01Q 1/32

(52) U.S. Cl. CPC H01Q 1/20; B23P 11/02; B23P 2700/50; H01Q 1/3275; H01Q 1/1214

(57) ABSTRACT

Disclosed is a method for producing a rod antenna for a vehicle, wherein a coil spring (10) is connected on at least one of its two ends to an antenna component, and wherein the connection between the coil spring (10) and the antenna component is established by expanding the inner diameter of the coil spring (10), by at least partially sliding the antenna component into the expanded coil spring (10), and by subsequently returning the coil spring towards the original inner diameter for securing purposes. The invention is characterized in that a wire (18) is inserted into the intermediate region between the coil spring (10) and the antenna component when the coil spring (10) is expanded.

The invention relates to a method of making a vehicular rod antenna in which a coil spring is connected to an antenna component at at least one of its two ends and also relates to a tool assembly for carrying out the method according to the features of the respective preambles of the two independent claims.

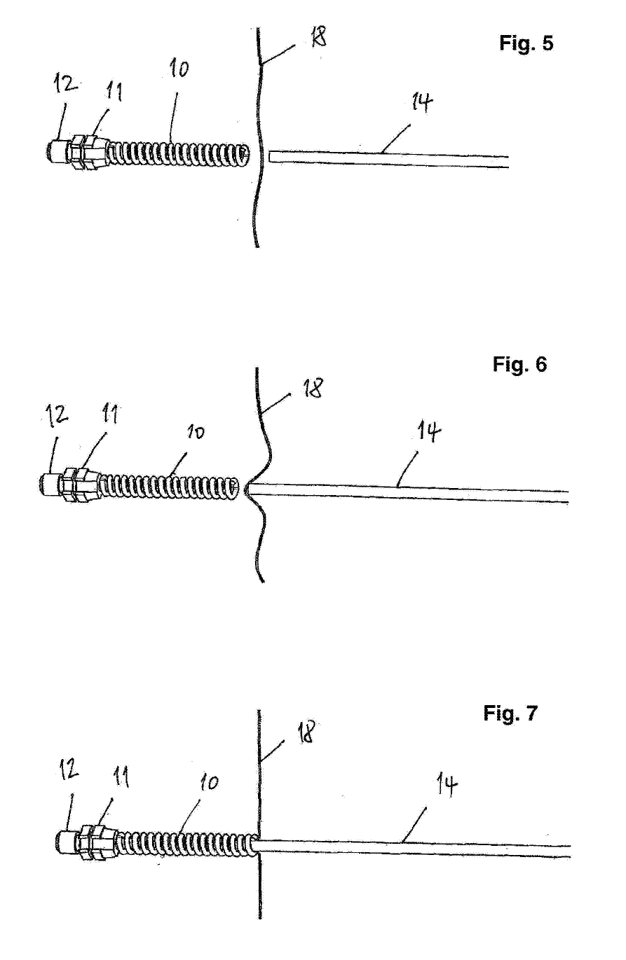

Rod antennas for vehicles are inherently known. They are removably mounted on a body surface, for example a vehicle roof, and particularly constitute a lambda quarter rod for receiving high-frequency signals. Such rod antenna is known, for example, from DE 10 2006 055 022. In this rod antenna, a connecting piece of a fastening element is formed with an antenna coil. Difficulties arise, however, because these two components must be aligned with one another due to the design of the antenna as a rod. This situation is shown in FIG. 5 of this reference. A coil spring 50 is to be operatively connected to a mount 51 and/or an antenna rod 52. To achieve this, it is necessary to affix a part of the mount 51 or an end of the antenna rod 52 in an attachment region 53 within the coil spring 50. For this purpose, the corresponding areas of the mount 51 and the antenna rod 52 are pressed into this attachment region 53, with high forces being required to permanently attach these components to the coil spring 50, since a rod antenna having such a design is subjected to high forces (e.g. wind, mechanical effects during washing of the vehicle, and the like) during operation of the vehicle.

A method with the features of the preamble of claim 1 is known from DE 10 2017 105 114.

It is therefore the object of the invention to provide a corresponding method of making a rod antenna and an associated tool assembly for carrying out the manufacturing method that enable simple assembly while simultaneously nonetheless enabling the components to be fastened permanently to one another and enabling a rod antenna to be assembled.

This object is achieved by the features of the two independent claims.

With regard to the method of making a rod antenna, a provision is made according to the invention that the connection between the coil spring and the antenna component is achieved by expanding the inner diameter of the coil spring through the at least partial insertion of the antenna component into the expanded coil spring and the subsequent return of the coil spring toward its original inner diameter for the purpose of attachment, with a wire being placed into the intermediate region between the coil spring and the antenna component while the coil spring is expanded. Through application of force to the coil spring, which has an original inner diameter, this inner diameter is increased, so that it is possible to insert the antenna component with its attachment region in alignment into the corresponding attachment region of the initially expanded coil spring so as to be flush. After this has been done, the force to expand the coil spring is removed, so that the coil spring contracts and returns to its original and smaller inner diameter. At the same time, the attachment region of the coil spring surrounds the attachment region of the antenna component under sufficiently high prestress, so that these two components are interconnected permanently and in alignment. It is important to ensure that the outer diameter of the attachment region of the antenna component is at least slightly larger than the original inner diameter of the coil spring, so that the inner portion of the coil spring bears radially against this attachment region upon returning to its original inner diameter. Tolerances are thus compensated for in an advantageous manner, particularly when the outer diameter of the attachment region of the antenna component is greater than the inner diameter of the coil spring and, in particular, fluctuates during the series production of antenna components.

According to the invention, the attachment of the coil spring to the antenna component continues to be maintained through expansion and contraction (interference fit), and the state of the expanded coil spring is exploited in order to insert a wire into the intermediate region between the outer contour of the antenna component and the inner surface of the coil spring. Preferably, one of the ends of the wire is inserted. The wire can have an outer sheath (made of plastic or paint or the like), but it is also conceivable for the sheath to be removed from the wire at least partially, particularly at its end. In such a case, an electrical contact is formed there between the wire and the antenna component and/or the coil spring, provided that the antenna component and/or the coil spring is also made of an electrically conductive material. The wire can thus be fixed very quickly and easily to the antenna component and the coil spring so that it is advantageously accessible for further use. In addition to the mechanical fixing of the wire between the coil spring and the antenna component, the electrical contacting can also occur simultaneously with the described expanding and the described contracting, thus eliminating the need for integral connections such as solder joints, for example.

According to a development of the method according to the invention, a fastening pin of a mount can fitted with the wire into an end of the coil spring and fixed in place and/or an antenna rod can be fitted into the coil spring and fixed in place. The coil spring, on the one hand, serves for receiving and/or developing the high-frequency signals that are received by the antenna rod. At the same time, the coil spring imparts flexibility to the entire rod antenna in order to allow a certain amount of bending during operation of the rod antenna on the vehicle that would not exist with a continuous rigid rod. The mount allows the rod antenna to be screwed into position, for example, into a holder on the vehicle having a corresponding mating thread. As a result, the finished rod antenna can be securely attached to the vehicle but while being easily removable. A portion of the rod antenna can be advantageously formed by the wire. For this purpose, the wire, which is fixed between the rigid rod, for example a glass-fiber rod, and the coil spring, is pre-wound or otherwise wound around the rigid rod to form a support with the antenna thereon. As a result, such a rod antenna can be assembled very quickly and easily; after all, not only can the connection between the mount and the coil spring on the one hand and the coil spring and the rigid rod on the other hand be made in a quick and simple manner by the method according to the invention, an additional subregion can be used for the function of the rod antenna through the fixing of the wire in place. Besides the use of a rigid rod, a rod-shaped structure can also be used that has yielding properties within narrow limits.

The other embodiments always relate to the fact that the wire is in the expanded area between the coil spring and the rod or between the coil spring and the attachment region of the mount.

Regarding the attachment of the antenna rod to the coil spring, a provision is made in a development of the invention that the antenna rod is attached with its one end (i.e. with only a short attachment region and not over the entire length) in the end of the coil spring that is opposite the mount. This makes it possible to achieve the required flexibility of the finished rod antenna. Depending on the length and intended use of such a rod antenna assembled according to the invention, however, consideration can also be given to inserting the antenna rod over a greater length (up to halfway, for example) or even completely into the coil spring (up to the area in which the fastening pin of the mount projects into the coil spring).

In a further development of the invention, the rod antenna can be provided with a sheath in order to protect it against external influences. Such a sheath is a separate component for example (e.g. a sleeve) that is pushed over the hitherto completed rod antenna. However, it is also conceivable for the sheath to be applied in an injection molding process or similar process.

A tool assembly for carrying out the method is also claimed. With this tool assembly, the method according to the invention can be carried out by executing the steps of expanding the coil spring, inserting the mount and/or the antenna rod, and the subsequent relaxing of the inner diameter of the coil spring.

In a development of the invention, the tool assembly has a holder for the at least one antenna component, namely for the mount and/or the antenna rod, as well as means for holding and expanding the coil spring. The above-described holder and the means for holding and expanding can be operated manually, but it is conceivable for the method according to the invention to be automated by means of a corresponding tool assembly.

The inventive approach to a solution is described again below:

### 1. Problem

The mounting of insulated copper wire on helical compression springs requires a soldering process after the assembly of attachments (glass fiber rods, threaded unions, etc.) in helical compression springs.

### 2. Approach to a Solution

The helical compression spring is expanded radially by a device. Due to the enlarged inner diameter, attachments can be positioned virtually without force and in an exact manner. During the positioning of the attachments, the copper wire is inserted between helical compression spring and glass fiber rod. Upon relaxation of the spring, the spring force presses the copper wire against the glass fiber rod, whereby the copper wire is fixed in place and contacted.

### 3. Implementation

The (coil) spring is expanded by introducing a force or a torque at a suitable point in the diameter. The copper wire is now inserted together with the glass fiber rod into the prestressed spring. The relaxation of the spring now ensures mechanical fixation and electrical contact.

### 4. Procedure

1) The spring is placed into the device and optionally locked.
2) The spring is prestressed axially.
3) The ends of the spring are placed against stops.
4) The spring is expanded by turning at least one stop.
5) The attachments are positioned in the spring along with the copper wire.
6) By turning back the stop, the spring is relieved and the wire contacted.
7) The attachments are clamped and the assembly can be removed.

### 5. Use

(Pre-)installation of antenna rods in which the use of a coil spring, especially a helical compression spring, is indispensable due to increased demands on the allowable bending, such as a reduced bending radius or extended bending angle. This eliminates the subsequent contacting of the copper wire to the coil spring by means of a soldering process.

The known method will be described below with reference to FIGS. 1 to 3.

A tool assembly for carrying out the method according to the invention is also described below and is shown in FIG. 4.

The method according to the invention will be also be described below with reference to FIGS. 5 to 7.

FIG. 1 shows the first step of the method of making a rod antenna, in which a force is applied to a coil spring in order to expand it. An antenna component has a mount 11 with a screwthread 12 and a fastening pin 13 and connected to an antenna rod 14 permanently by a coil spring 10 in this embodiment. Reference numeral 15 denotes the diameter ratios at the mount 11. The outer diameter of the fastening pin 13 is fixed and, expansion 16, is smaller than the spring so that it can be pushed into the expanded attachment region of the coil spring 10 without any application of force. The same applies to the antenna rod 14 that can be inserted without the application of appreciable force into the corresponding attachment region of the expanded coil spring 10. Even though it is shown near the right end of the coil spring 10 in FIG. 1 that the inner diameter of the last winding of the coil spring 10 corresponds approximately to the outer diameter of the antenna rod 14, the antenna rod 14 can be readily inserted into the interior of the coil spring 10 because the end of the winding of the coil spring 10 can also be expanded without applying much force, and the antenna rod 14 can be inserted into the other windings of the coil spring 10 (toward the left in FIG. 1).

FIG. 2 shows the state in which the at least one antenna component, namely the mount 11 and/or the antenna rod 14, has been inserted by displacement 17 into the interior of the coil spring 10. During this process, the coil spring 10 is still expanded, that is, an external force is still applied to the coil spring 10 for the expansion 16.

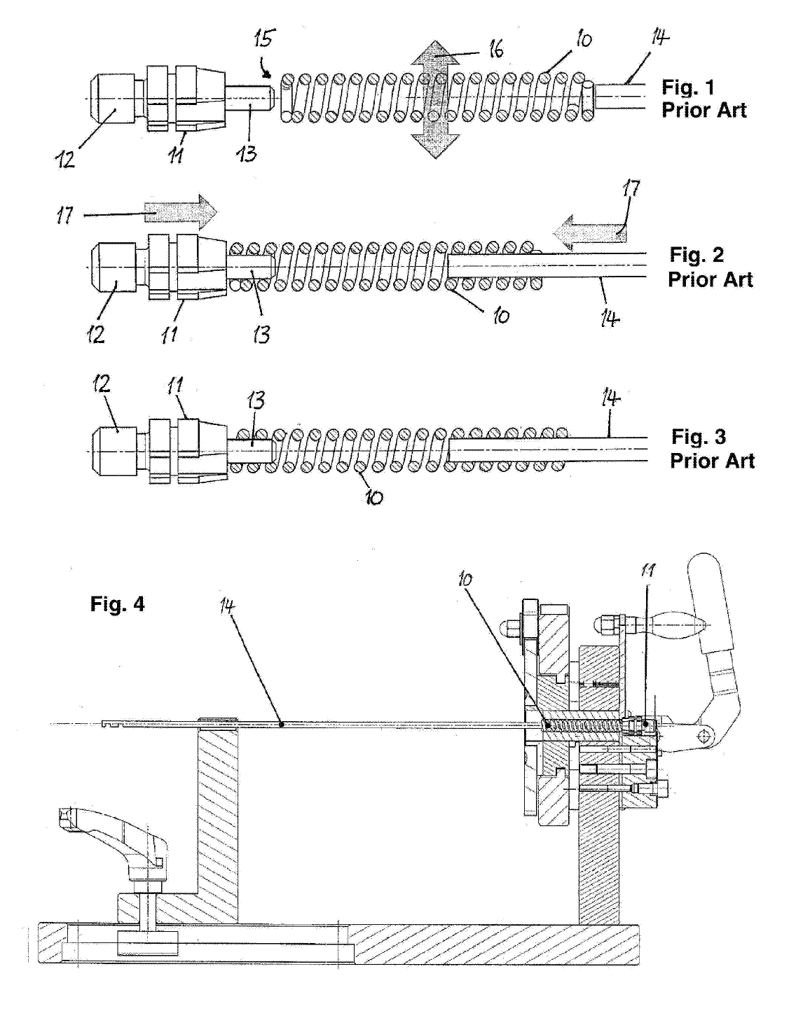

Finally, FIG. 3 shows that the external force for expansion 16 has been removed from the coil spring 10, so that the end windings of the coil spring 10 are under prestress around the fastening pin 13 and fix the latter permanently in place. The same applies to the end windings of the coil spring 10 at the antenna rod 14. An unillustrated sheath can be provided that begins approximately to the left of the fastening pin 13 of the mount 11 and extends at least over the coil spring 10, but preferably also over the antenna rod 14 (directional information refers to a consideration of FIG. 3).

For the sake of completeness, it should be mentioned that here (in particular FIG. 3), the antenna rod 14 is only partially inserted and into a portion of the coil spring 10 and fixed (clamped) in place. However, it is also conceivable for the antenna rod 14 to be inserted with its one end even farther into the coil spring 10, particularly up to the fastening pin 13.

FIG. 4 shows a tool assembly that can be operated manually to make a rod antenna. A holder for the mount 11 and means for holding and expanding the coil spring 10 are shown. The method according to the invention can be carried out with the aid of this holder and the means for holding and expanding the coil spring. If the rod antenna also has an antenna rod, this antenna rod 14 is clamped in an additional holder, in which case this holder as well as the holder for the mount extend axially of the coil spring 10 for the purpose of insertion (insertion process 17). After the coil spring 10 has been expanded and the mount 11 has been inserted with its fastening pin 13 and/or the antenna rod 14 has been inserted into the attachment region of the coil spring 10, this external force is removed from the coil spring 10, so that they can contract and thereby clamp the fastening pin 13 and/or the antenna rod 14 in the attachment region. In the illustrated tool assembly, it is important that the central axis of the mount 11, the central axis of the coil spring 10 and, if present, the central axis of the antenna rod 14 are coaxial in order to be able to make a rod-shaped antenna (rod antenna).

While the tool assembly shown is operated manually, an automated production of a rod antenna is also conceivable as an alternative.

FIGS. 5 to 7 show the method according to the invention in which a rod antenna is assembled on the basis of the method steps illustrated in FIGS. 1 to 3.

The components such as the coil spring 10, the mount 11, and the antenna rod 14, for example, are retained. In addition, there is a wire 18 that, in the embodiment according to the FIGS. 5 to 7, is to be clamped between the antenna rod 14 and the coil spring 10.

FIG. 5 shows that the wire 18 has been moved with a portion into the region between the coil spring 10 and the antenna rod 14.

FIG. 6 shows that the one end of the antenna rod 14 entrains the portion of the wire 18, with the coil spring 10 being expanded in this state by an unillustrated mechanism and/or force effect such that the wire 18 can be inserted together with the antenna rod 14 into the expanded inner region of the coil spring 10.

Finally, FIG. 7 shows that the portion of the wire 18 that has been placed around the end of the antenna rod 14 has been pushed into the expanded inner region of the coil spring 10. After this has been done, the force acting on the coil spring 10 in order to expand it is removed, so that the coil spring 10 contracts and the wire 18 is fixed in place at least mechanically in the end of the antenna rod 14. If the coil spring 10 and/or the antenna rod 14 are made of an electrically conductive material and, at the same time, at least the portion of the antenna rod 14 is also electrically conductive, not only the mechanical fixing occurs, but also the electrical contacting.

FIGS. 5 to 7 show that the wire 18 is attached to the coil spring 10 in conjunction with the antenna rod 14. Alternatively or in addition, it is also conceivable for the wire 18 (and optionally an additional wire) to be fixed in place not only in the end of the antenna rod 14, but also in the attachment region 13 of the mount 11.

In order to form the finished rod antenna, the fixed wire 18 according to FIG. 7 is wound more coil or screws for Mac around the antenna rod 14, with the pitch being adapted to the function of the finished rod antenna.

The wire 18 is advantageously a copper wire that is sheathed with a paint, although materials other than copper can be conceivably used for the wire 18 and materials other than paint can be conceivably used for the sheath of the wire 18.

List of reference symbols

| | |
|---|---|
| 10 | coil spring |
| 11 | mount |
| 12 | thread |
| 13 | fastening pin |
| 14 | antenna rod |
| 15 | diameter ratio |
| 16 | expansion |
| 17 | displacement |
| 18 | wire |
| 50 | coil spring |
| 51 | mount |
| 52 | antenna rod |
| 53 | attachment region |

1. In a method of making a vehicular rod antenna comprising a coil spring connected at at least one of its ends to an antenna component by expanding the inner diameter of the coil spring through the at least partial insertion of the antenna component into the expanded coil spring such that the subsequent return of the coil spring toward its original inner diameter serves for its attachment, the improvement wherein a wire is placed into an intermediate region between the coil spring and the antenna component while the coil spring is expanded.

2. The method according to claim 1, wherein the antenna component is a fastening pin of a mount and is arranged and fixed in place in the one end of the coil spring.

3. The method according to claim 1, wherein the antenna component is an antenna rod arranged at least partially in the coil spring and fixed in place.

4. The method according to claim 3, wherein the antenna rod has an end fixed in the one end of the coil spring.

5. The method according to claim 1, wherein the rod antenna is provided with a sheath.

6. A tool assembly for carrying out the method according to claim 1.

7. The tool assembly according to claim 6, wherein the tool assembly has a holder for a mount and/or the antenna rod and means for holding and expanding the coil spring.

8. A method of making a rod antenna, the method comprising the steps of:
elastically expanding an inner diameter of a coil spring having two opposite ends;
inserting into one of the ends a fastening pin of a mount;
positioning a wire across the other end of the spring;
pushing an antenna rod against the wire and into the other end of the spring such that the wire is positioned inside the spring between the spring and the rod; and
relaxing the spring such that the inner diameter of the spring decreases and the ends of the spring radially grip the pin and the rod and the wire is compressed against the rod.

9. The method defined in claim 8, wherein the rod and the pin are each inserted into the spring such that an empty space is left inside the spring between the pin and the rod.
